(19) United States
(12) Patent Application Publication
(10) Pub. No.: US 2024/0070290 A1
(43) Pub. Date: Feb. 29, 2024

(54) INFORMATION PROCESSING APPARATUS, INFORMATION PROCESSING METHOD AND SYSTEM

(71) Applicants: KABUSHIKI KAISHA TOSHIBA, Tokyo (JP); TOSHIBA INFRASTRUCTURE SYSTEMS & SOLUTIONS CORPORATION, kawasaki-shi Kanagawa (JP)

(72) Inventors: Ryuiti KOIKE, Kawasaki Kanagawa (JP); Tatsuya UEHARA, Kawasaki Kanagawa (JP); Hayeong SHIN, Yokohama Kanagawa (JP); Jun KANAI, Inagi Tokyo (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(21) Appl. No.: 18/174,714

(22) Filed: Feb. 27, 2023

(30) Foreign Application Priority Data
Aug. 31, 2022 (JP) 2022-138615

(51) Int. Cl. G06F 21/57; G06F 8/71

(52) U.S. Cl. CPC G06F 21/577; G06F 8/71; G06F 2221/033

(57) ABSTRACT

An information processing apparatus according to one embodiment, comprising: a first vulnerability information obtainer configured to obtain, from a first server, first vulnerability information; a second vulnerability information obtainer configured to obtain, from a second server, second vulnerability information; a first configuration information obtainer configured to obtain first configuration information included in the target device; a scanner configured to detect a first identifier, from the first vulnerability information, based on the first configuration information, and identify the vulnerability identifier associated with the detected first identifier; a searcher configured to identify a second identifier that is associated with the vulnerability identifier identified, and includes a name of software identical to the name of the target software, based on the second vulnerability information; and an output processor configured to generate a third identifier by replacing the version included in the second identifier identified with the version of the target software.

### CROSS REFERENCE TO RELATED APPLICATIONS

This application is based upon and claims the benefit of priority from the prior Japanese Patent Application No. 2022-138615, filed on Aug. 31, 2022, the entire contents of which are incorporated herein by reference.

### FIELD

Embodiments described herein relate to an information processing apparatus, an information processing method, and a system.

### BACKGROUND

Each day information on the vulnerabilities of various products (vulnerability information) is disclosed on public servers (versatile information servers) across the world. Manufacturers of products are required to determine whether the disclosed vulnerabilities are included in the products manufactured by these manufacturers. Accordingly, there is an increasing need for a vulnerability monitor system that detects the vulnerabilities by collecting the vulnerability information disclosed each day and comparing the information with information on devices (products).

On the versatile information server, the vulnerability is associated with configuration information that indicates a component, such as software, affected by the vulnerability. On the versatile information server, a versatile and global identifier called CPE (Common Platform Enumeration) is used to represent the configuration information. Accordingly, the manufacturer can determine whether a CPE identical to a CPE indicating information on a component included in a device manufactured by the manufacturer is disclosed or not, by viewing the CPE on the versatile information server. If disclosed, the manufacturer determines which vulnerability is included in the device manufactured by this manufacture. Thus, in the vulnerability monitor system, configuration information on the device is required to be described in a predetermined format of CPE and stored. However, the format of CPE is complicated, creation of the CPE is accompanied by difficulty, and manual creation costs much (time and expense).

### BRIEF DESCRIPTION OF THE DRAWINGS

FIG. 1 is a block diagram of a vulnerability monitor system according to one embodiment;

FIG. 2 shows an example of first configuration information;

FIG. 3 shows an example of first vulnerability information;

FIG. 4 shows an example of second vulnerability information;

FIG. 5 shows an example of second configuration information;

FIG. 6 is a flowchart showing an example of processes of a vulnerability monitor system;

FIG. 7 is a block diagram of a configuration information converter according to a first configuration example of one embodiment;

FIG. 8 shows version-invalidated first configuration information, and information in a first vulnerability database;

FIG. 9 shows first configuration information, and version-invalidated information in the first vulnerability database;

FIG. 10 is a flowchart showing an example of processes of the configuration information converter;

FIG. 11 is a block diagram showing a configuration information converter according to a second configuration example of one embodiment;

FIG. 12 is a block diagram of a configuration information converter according to a third configuration example of one embodiment;

FIG. 13 is a block diagram of a configuration information converter according to a fourth configuration example of one embodiment; and

FIG. 14 shows a hardware configuration of an information processing apparatus according to one embodiment.

### DETAILED DESCRIPTION

According to one embodiment, an information processing apparatus, includes a first vulnerability information obtainer, a second vulnerability information obtainer, a first configuration information obtainer, a scanner, a searcher and an output processor.

The first vulnerability information obtainer obtains, from a first server specific to a platform, first vulnerability information that associates a first identifier identifying software related to the platform, with a vulnerability identifier identifying a vulnerability of the software. The first identifier identifies by a name and a version of the software.

The second vulnerability information obtainer obtains, from a second server, second vulnerability information that associates a second identifier identifying software included in a device according to a predetermined format, with the vulnerability identifier. The second identifier identifies by a name and a version of the software.

The first configuration information obtainer obtains, from a vulnerability test target device, first configuration information that includes a name and a version of target software included in the target device.

The scanner detects a first identifier including the name of the target software, from the first vulnerability information, based on the first configuration information, and identify the vulnerability identifier associated with the detected first identifier.

The searcher identifies a second identifier that is associated with the vulnerability identifier identified by the scanner, and includes a name of software identical to the name of the target software, based on the second vulnerability information.

The output processor generates a third identifier by replacing the version included in the second identifier identified by the searcher with the version of the target software, the third identifier identifying the target software included in the target device, according to the predetermined format.

Hereinafter, referring to the drawings, embodiments of the present invention are described.

[Overview of Entire Vulnerability Monitor System 1]

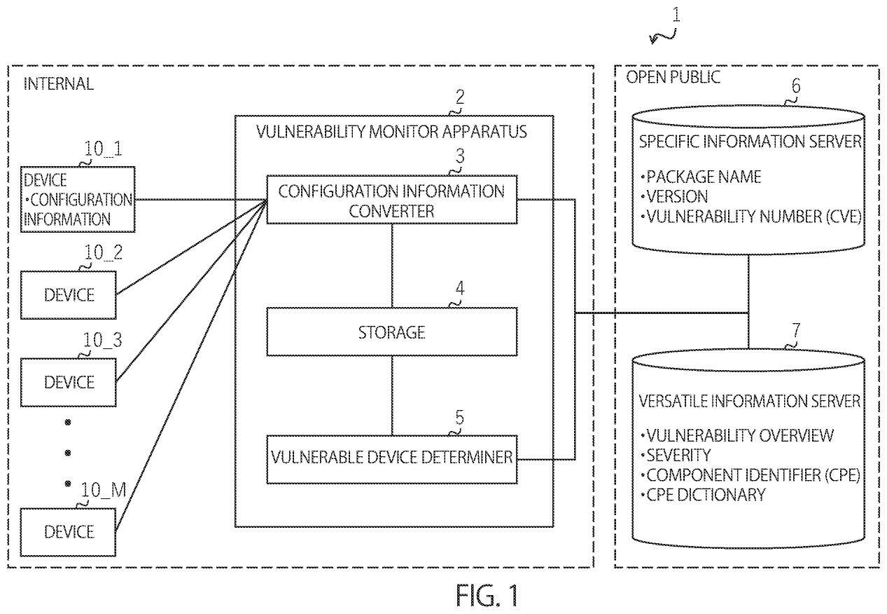

FIG. 1 is a block diagram showing a vulnerability monitor system 1 that is an information processing system according to one embodiment. Hereinafter, an overview of the entire vulnerability monitor system 1 is described.

The vulnerability monitor system 1 includes a vulnerability monitor apparatus 2, a specific information server 6, a versatile information server 7, multiple types of devices 10_1 to 10_M (M≥1). “M” represents the number of types of the devices 10, but does not represent the number of devices. Hereinafter, any type “i” of a device 10 is described as a device 10_i (i=1 to M).

The vulnerability monitor system 1 collects configuration information on the multiple types of devices 10_1 to 10_M that are products before shipment, and constantly monitors vulnerabilities that can occur in the products (devises 10_i). If any vulnerability is detected, the system notifies this detection to a user of the vulnerability monitor system 1.

One or more pieces of software that achieve various functions are installed in the devices 10_i of the type “i”. Typically, various types of devices 10_i exist, and respectively include different pieces of configuration information. The devices 10_i are, for example, PCs, or IoT (Internet of Things) target devices.

The configuration information is information indicating which components (software etc.) constitute the device 10_i. For example, the configuration information is information, such as “the device 10_i includes software 1 and software 2”.

Software specific to a certain platform (e.g., an OS) is installed, in a unit of a “package”, in the device 10, in a case where the platform is Linux, for example. The package integrally includes execution files, setting files, documents and the like of the software. Also on platforms other than Linux, a set of software is typically managed by a mechanism corresponding to a package. Hereinafter, for the purpose of description, software specific to a certain platform is sometimes described as “package”. However, this does not limit the platform only to Linux.

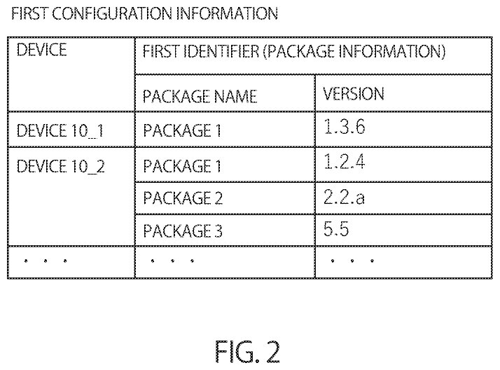

FIG. 2 shows an example of configuration information (first configuration information) on devices 10_1 to 10_M. That is, FIG. 2 shows an example of information (package information) on a package installed in the devices 10_1 to 10_M. The package information includes the name of the package (package name), and the version of the package. The package information is an identifier (first identifier) that is provided by the platform and is unique to the platform. That is, the configuration information included in the device 10_i is specific to the platform, and is not versatile. A certain package is uniquely identified by the name and the version of the package.

In the example in FIG. 2, “PACKAGE 1” with “VERSION 1.3.6” is installed in the device 10_1. Note that the platform of the package installed in the same type of devices 10_i are not required to be unified. Hereinafter, for the sake of description, the package installed in the device 10_1 is sometimes described as a package X (target software).

The specific information server 6 accumulates and discloses vulnerability information (first vulnerability information) found each day across the world. The specific information server 6 is a server open to the Internet. Any person can view the content.

The specific information server 6 is a server provided by a certain vendor for a platform provided by the vendor. The vulnerability information with content specialized in use on the platform is described in the specific information server 6. The vendor manages products belonging to the platform, with responsibility. For example, the specific information server 6 provided by a Linux distributor has accumulated information in which vulnerabilities can be securely found about the package installed in Linux.

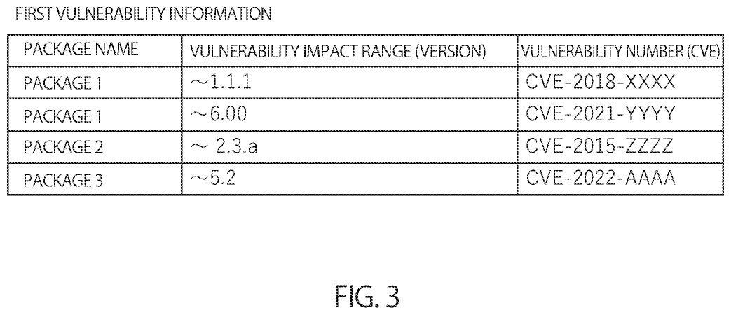

FIG. 3 shows an example of the first vulnerability information that the specific information server 6 has. The vulnerabilities are uniquely identified respectively by vulnerability numbers. As shown in FIG. 3, on the specific information server 6, the vulnerability number corresponds to the package name and the version (range) of the package affected by the vulnerability. For example, it is indicated that the vulnerability indicated by a vulnerability number “CVE-2018-XXXX” has an impact on the “PACKAGE 1” with versions to the version “1.1.1”.

On the specific information server 6, the description details of the package names, the affected versions (range), and the vulnerability numbers do not have ambiguity or any error. If there is any error, the error is highly possibly corrected immediately.

Note that the vulnerability impact range is sometimes defined, as “0.5.1 to 1.1.1”, with the upper limit and the lower limit. However, in actuality, packages other than the package with the latest version often have a vulnerability. Therefore, on the specific information server 6, a definition where the impact range only includes the upper limit dominates. Hereinafter, realistic registration content is premised, and it is assumed that the impact range is defined only by the upper limit.

The vulnerability number is, for example, a CVE (Common Vulnerabilities and Exposures). The CVE is described by an issuance year and a serial number. CVE is common to the entire world, and is thus common to the specific information server 6 and the versatile information server 7.

Both the device 10_i and the specific information server 6 use the first identifier (the package name and the version (range)). This is because the specific information server 6 is assumed to be used mainly by a vulnerability scanner (scanner) specific to the platform. The scanner is software that determines whether the package includes a vulnerability or not from package information on the package on the test target platform.

For example, it is assumed that a package X that is “package 1” with “version 1.3.6” is installed in a device 10_1 (target device) serving as a target of a test by the scanner. Based on information shown in FIG. 3, the scanner identifies that the package X is a “package 1” and the version of the package X is higher than “1.1.1”, and determines that the target device does not include a vulnerability “CVE-2018-XXXX”. Likewise, the scanner identifies that the version of the package X is lower than “6.0.0”, and determines that the package X includes a vulnerability “CVE-2021-YYYY”.

The versatile information server 7 accumulates and discloses vulnerability information (second vulnerability information) found each day across the world. The versatile information server 7 is a server open to the Internet. Any person can view the content.

The versatile information server 7 does not depend on any specific platform. Versatile information is described in this server. Here, “versatile information” indicates information that any person can read and understand, and does not include information beneficial only to a specific platform. Accordingly, on the versatile information server, a versatile identifier (second identifier) is used to represent the configuration information. The second identifier is, for example, the CPE. The versatile information server 7 is, for example, the NVD (National Vulnerability Database). The description is hereinafter made assuming that the second identifier is the CPE.

The CPE is an identifier that describes a component, such as software (package), included in a certain device, in a predetermined format, and uniquely identifies the component. For example, one piece of software included in a certain device is described by one CPE. Accordingly, a plurality of CPEs are associated with a device that includes a plurality of pieces of software. The components can include hardware and OSs besides software.

The CPE is described in a predetermined format (CPE format). The CPE format is, for example, the URI format. Specifically, elements for uniquely identifying the component are described as “cpe:/type:vendor_name: product_name:version:update:edition:language”.

The platform type of the component, such as hardware(h), OS (o), and application(a), is described in “type”. The name of the vendor of the component is described in “vendor_name”. The name of the component as a product is described in “product_name”. A specific numeral indicating the version of the component is described in “version”. Information on the update of the product and the service pack is described in “update”. A way of providing the product is described in “edition”. The language used in the product is described in “language”. Each component is appropriately omitted as required. If any element follows thereafter, the element may be replaced with an asterisk (*).

The CPE is recommended to identify one piece of software or the like by using an existing vendor name and product name and then by the element of the version and thereafter, according to the rule.

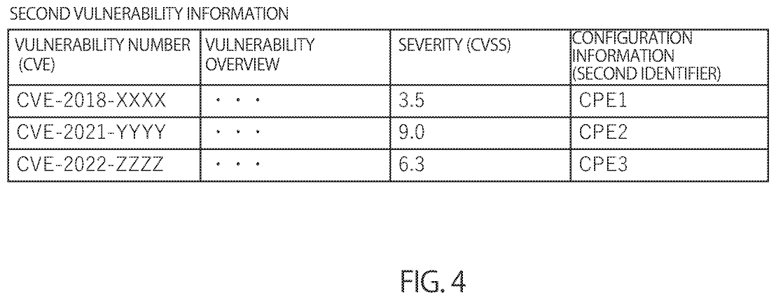

FIG. 4 shows the second vulnerability information that the versatile information server 7 has. As shown in FIG. 4, the versatile information server 7 accumulates vulnerability information in which vulnerability overview, severity, and configuration information described by the second identifier are included. The vulnerability information is uniquely identified by the vulnerability number (CVE). The vulnerability overview is written in a natural language. The severity of the vulnerability is evaluated by CVSS, for example. The configuration information described in the CPE format is associated with one vulnerability. That is, on the versatile information server 7, the vulnerability (vulnerability number) is associated with the configuration information which is described by the second identifier and which the vulnerability affects.

A party that can describes the first configuration information included in the device 10_i by the second identifier can identify the vulnerability included in the device 10_i from the second vulnerability information on the versatile information server 7. For example, a party knowing that the component indicated by “CPE1” is included in the device 10_i can know that the vulnerability “CVE-2018-XXXX” is included in the device 10_i.

The vulnerability monitor apparatus 2 includes a configuration information converter 3, a storage 4, and a vulnerable device determiner 5. The vulnerability monitor apparatus 2 collects the configuration information from the devices 10_1 to 10_M before shipment, and saves the collected information. When a vulnerability is found in the device 10, the apparatus notifies a warning to the user of the vulnerability monitor system 1. Specifically, when the vulnerability information is disclosed on the versatile information server 7 and/or the specific information server 6, the component that the vulnerability affects is identified from the identifier associated with the vulnerability. If the component is included in any of the devices 10_1 to 10_M, the warning is notified to the user of the vulnerability monitor system 1.

However, as described above, the first configuration information on the device 10_i is described by the first identifier. Accordingly, the information, as it is, is not associated with the second vulnerability information disclosed on the versatile information server 7. Second configuration information obtained by converting the first identifiers on the first configuration information collected from the devices 10_1 to 10_M, into third identifiers (described as CPE's) described according to the same format (CPE format) as that of the second identifiers, is required to be generated. Here, vulnerability detection using the first vulnerability information on the specific information server 6 can be performed using the first configuration information obtained from the device 10_i, as it is, without conversion. Since the operation is evident, the description of the operation is appropriately omitted.

First, the configuration information converter 3 collects the first configuration information from the devices 10_1 to 10_M. Since various types of devices 10 exist, the configuration information converter 3 collects the first configuration information without depending on a specific platform.

The configuration information converter 3 then converts the collected first configuration information into the second configuration information described by the third identifier (CPE′), and outputs the converted information. A specific conversion method is described later.

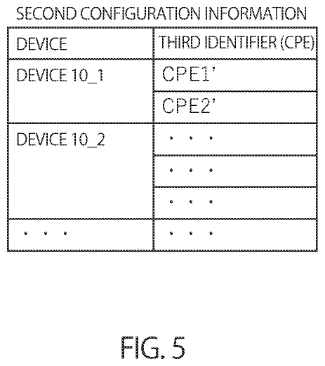

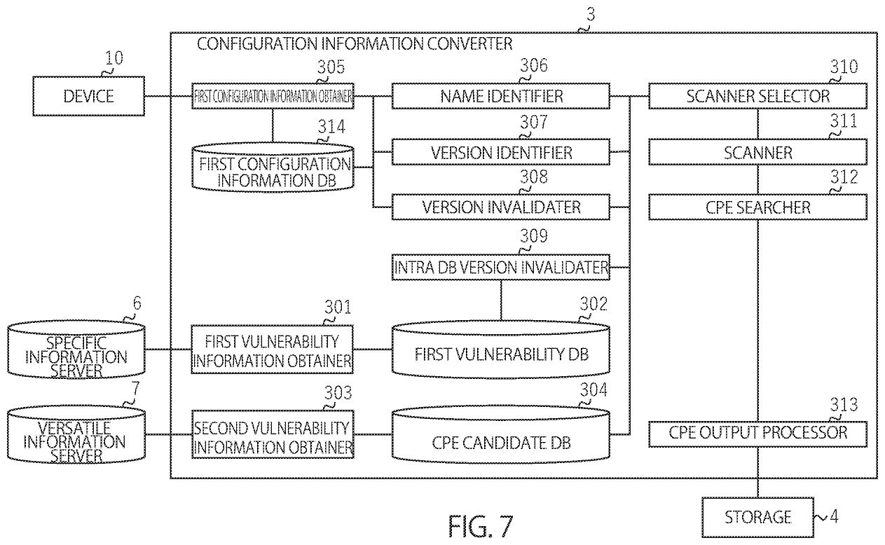

FIG. 5 shows an example of the second configuration information output by the configuration information converter 3. As shown in FIG. 5, the configuration information on the devices 10_i are preliminarily described by the third identifiers, thereby allowing the second vulnerability information on the versatile information server 7 to be used to detect the vulnerabilities of the devices 10_i. As described later, the CPE′ can be generated by replacing the version part of the CPE (second identifier) identified by a CPE searcher 312 (see FIG. 7) with the version of the software (target software) in the device 10_i serving as a target. The CPE′ associates the software in the device 10_i serving as a target, with the third identifier described in a predetermined format (the CPE format in this embodiment) that includes the name and the version of the software.

The storage 4 stores the second configuration information output by the configuration information converter 3. Even in a case where the device 10_i has been shipped and the actual product of the device 10_i is not at hand of the user (manufacturer), presence of the storage 4 allows the second configuration information on the device 10_i to be retrospectively verified. Note that the storage 4 may store the first configuration information.

The vulnerable device determiner 5 constantly monitors the versatile information server 7. When new second vulnerability information is disclosed on the versatile information server 7, the vulnerable device determiner 5 obtains the second vulnerability information. The vulnerable device determiner 5 then compares the second identifier included in the second vulnerability information with the third identifier included in the second configuration information stored in the storage 4. If the matched second identifier exists in the second vulnerability information, it is determined that the vulnerability is included in the device 10_i in the second configuration information that includes the third identifier. Note that the vulnerable device determiner 5 may detect the vulnerability in the devices 10_i using the first configuration information and the first vulnerability information, similar to the above description.

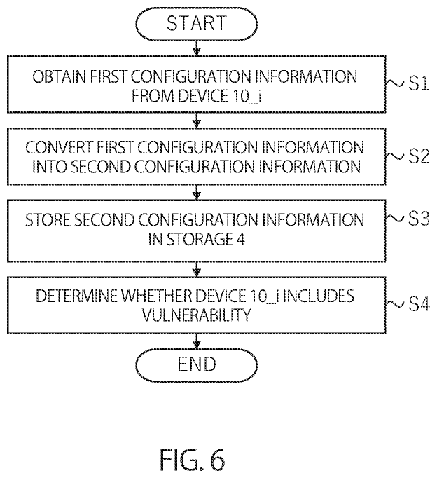

FIG. 6 is a flowchart of processes performed by the vulnerability monitor apparatus 2. Hereinafter, referring to FIG. 6, the processes performed by the vulnerability monitor apparatus 2 are described.

First, the configuration information converter 3 obtains the entire first configuration information on the devices 10_i from the devices 10_i (step S1).

Next, the configuration information converter 3 converts the first configuration information into the second configuration information (step S2).

Next, the configuration information converter 3 stores the second configuration information in the storage 4 (step S3).

Next, the vulnerable device determiner 5 compares the third identifier included in the second configuration information stored in the storage 4 with the second identifier included in the second vulnerability information on the versatile information server 7. If both match each other, it is determined that the vulnerability is included in the device 10_i that includes the second configuration information including the third identifier (step S4).

As described above, the vulnerability monitor system 1 can detect the vulnerability of the device 10_i that includes the configuration information described by the first identifier, using the second vulnerability information described by the third identifier.

<Configuration Information Converter 3>

### First Configuration Example

FIG. 7 is a block diagram of the configuration information converter 3 that is an information processing apparatus according to a first configuration example of one embodiment. Hereinafter, details of the configuration of the configuration information converter 3, and processes performed by the configuration information converter 3 are described.

As described above, the configuration information converter 3 is a device for converting the first configuration information obtained from the devices 10_1 to 10_M into the second configuration information.

To convert the first configuration information into the second configuration information described by the CPE, a method of using a CPE dictionary disclosed by the versatile information server 7 may be adopted. The CPE dictionary describes the association between package information and the CPEs. However, according to the following historical background, the CPE dictionary has a problem as described below.

First, a large amount of CPEs are registered in the CPE dictionary. Accordingly, it is difficult to determine which CPE is an appropriate CPE. Here, “appropriate CPE” indicates a proven CPE having regularly been used for previous years by the versatile information server 7. As described below, the appropriate CPE does not necessarily have a correct description format.

Second, there are a large amount of inconsistent representation such that the representation of the vendor names and the software name are not regularized and the names are represented as commonly used names. Accordingly, it is difficult to determine which CPE is an appropriate CPE. Additionally, the vendor names and the software names are changed by acquisition or name change in some cases. However, in consideration of compatibility with past CPEs, some CPEs are described by conventional vendor names and software names.

Third, CPE description is not strictly checked. Accordingly, some CPEs include erroneous description. However, in consideration of compatibility with conventional CPEs, CPEs including erroneous description are continuously used in some cases.

Because of the reasons described above, it is difficult to convert the first configuration information even using the CPE dictionary. Even a party having full knowledge of the CPE description method cannot necessarily describe an appropriate CPE. In view of the above problem, the configuration information converter 3 is configured to convert the first configuration information using the first vulnerability information on the specific information server 6.

The configuration information converter 3 includes a first vulnerability information obtainer 301, a first vulnerability DB 302, a second vulnerability information obtainer 303, a CPE candidate DB 304, a first configuration information obtainer 305, a name identifier 306, a version identifier 307, a version invalidater 308, an intra DB version invalidater 309, a scanner selector 310, a scanner 311, a CPE searcher 312 (searcher), a CPE output processor 313 (output processor), and a first configuration information DB 314.

The first vulnerability information obtainer 301 obtains, from the specific information server 6, the first vulnerability information disclosed on the specific information server 6. The obtained first vulnerability information may be information itself disclosed by the specific information server 6 as shown in FIG. 3. The first vulnerability information obtainer 301 may periodically obtain the first vulnerability information from the specific information server 6, or obtain the first vulnerability information every time the first vulnerability information is updated on the specific information server 6.

The first vulnerability DB 302 stores the first vulnerability information obtained by the first vulnerability information obtainer 301. The first vulnerability DB 302 has preliminarily been initialized. The first vulnerability information is additionally updated each time by the first vulnerability information obtainer 301. This is because the information on the specific information server 6 changes on a daily basis.

It is hereinafter assumed that the first vulnerability DB 302 stores the information shown in FIG. 3. The first vulnerability DB 302 is a database that is used when the scanner 311 detects the vulnerability from the first configuration information on the device 10_i. When the package name and the version are identified, the CVE of the vulnerability included in the package can be identified by referring to the information in the first vulnerability DB 302.

Note that the save format of the first vulnerability DB 302 depends on the scanner 311 that uses the first vulnerability DB 302. The save format is the SQLite3 format, or CSV (Comma Separated Value) format, for example. As described later, an existing scanner may be diverted as the scanner 311. An information obtaining program accompanying the existing scanner may be diverted as the first vulnerability information obtainer 301. In this case, a plurality of first vulnerability DBs 302 may be respectively created for types of scanners and platforms.

The second vulnerability information obtainer 303 obtains, from the versatile information server 7, the second vulnerability information disclosed on the versatile information server 7. The obtained second vulnerability information may be information itself disclosed by the versatile information server 7 as shown in FIG. 4. Alternatively, the second vulnerability information obtainer 303 may parse and capture information disclosed by the versatile information server 7 as a website, or obtain the second vulnerability information disclosed in a structured state for facilitating program processing, such as JSON or XML. The second vulnerability information obtainer 303 may periodically obtain the second vulnerability information from the versatile information server 7, or obtain the second vulnerability information every time the second vulnerability information is updated on the versatile information server 7.

The CPE candidate DB 304 stores the second vulnerability information obtained by the second vulnerability information obtainer 303. The CPE candidate DB 304 has preliminarily been initialized. The second vulnerability information is additionally updated each time by the second vulnerability information obtainer 303. This is because the information on the versatile information server 7 changes on a daily basis.

It is hereinafter assumed that the CPE candidate DB 304 stores the information shown in FIG. 4. The CPE candidate DB 304 is a database that the after-mentioned CPE searcher 312 uses when identifying the CPE from the CVE, and is only required to store at least the pair of the CVE and the CPE. Accordingly, for the purpose of improving the processing speed and reducing the save capacity, the CPE candidate DB 304 may appropriately remove elements (the vulnerability overview, the severity and the like shown in FIG. 4) other than the CVE and the CPE. The number of CPEs associated with one CVE is not necessarily one, can be two or more in some cases.

The first configuration information obtainer 305 obtains the entire first configuration information (package information) included in the device 10_i from the device 10_i. The first configuration information obtainer 305 is connected to the device 10_i before shipment through a network, and collects the first configuration information from the device 10_i at any timing. The first configuration information obtainer 305 may be wirelessly connected to the device 10_i through a wireless access point, or connected by wire including the Ethernet installed in a factory. The first configuration information obtainer 305 may collect the first configuration information from a manufacturer or the like of the device 10_i.

To collect the first configuration information, first, the first configuration information obtainer 305 determines the platform of the device 10_i, and subsequently accesses the device 10_i by an appropriate method and obtains the first configuration information. In a case where the platform is Linux, the first configuration information obtainer 305 may use an OS package management command, or refer to a software management file having already been installed. In a case where the platform is Windows, the first configuration information obtainer 305 may verify the details of the registry. The first configuration information obtainer 305 store the type of the platform for the device 10, in the first configuration information DB 314.

The first configuration information DB 314 stores the first configuration information on the device 10_i. The scanner 311 and the CPE searcher 312, which are described later, perform a process of identifying the CPE of the package. The process depends on the content of the first vulnerability DB 302 and the CPE candidate DB 304. Since the content of both the databases changes on a daily basis with change in the content of the specific information server 6 and the versatile information server 7, the process may be performed again at a later date. Accordingly, the first configuration information obtainer 305 may store, in the first configuration information DB 314, the first configuration information on the devices having been obtained so far.

The name identifier 306 identifies the package name in the first configuration information obtained by the first configuration information obtainer 305.

The version identifier 307 identifies the version of the package in the first configuration information obtained by the first configuration information obtainer 305. The name identifier 306 and the version identifier 307 store the package name and the version in the first configuration information DB 314.

The scanner 311 is a scanner that, upon receipt of the input first configuration information (the package name and the version), refers to the first vulnerability information on the specific information server 6, and determines presence or absence of the vulnerability included in the package indicated by the first configuration information.

The scanner 311 may be individually implemented. Alternatively, an existing commercial or open-source scanner may be diverted and adopted. In the case of use of the existing scanner, existing scanners different among platforms are required. Accordingly, the scanners 311 as many as the types of platforms of the packages included in the devices 10_1 to 10_M at the maximum are required. Hereinafter, description is made assuming that the scanner 311 is an existing scanner diverted therefor.

The scanner 311 is required to receive the first configuration information in a specific format. For example, there are a scanner 311 that receives the input of the first configuration information in a JSON-format file, and a scanner 311 that receives the input in an XML-format file. There are a scanner 311 that receives the input of the first configuration information through interprocess communication, and a scanner 311 that receives the input through TCP communication.

The scanner selector 310 determines the platform of the device 10_i, based on the first configuration information DB 314, and determines the scanner 311 capable of determining the vulnerability of the device 10_i among multiple scanners 311. Furthermore, an after-mentioned method of invalidating the version is also determined.

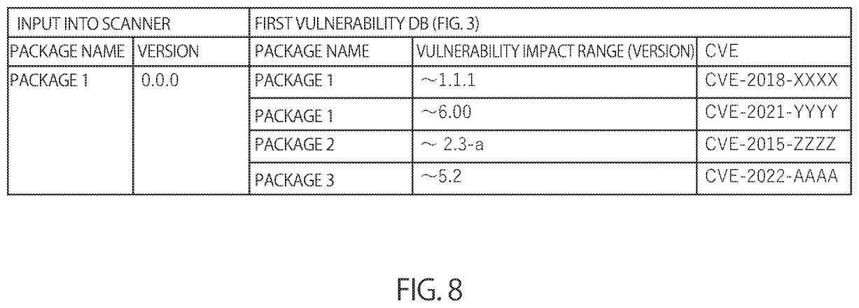

For preliminary preparation for a vulnerability scan to be performed by the scanner 311, the version invalidater 308 invalidates the version included in the first configuration information on the device 10_i to be input into the scanner 311. The version invalidater 308 rewrites the version of the first configuration information to be input into the scanner 311, to a value smaller than a value that the version is allowed to have. In this embodiment, for example, as shown in FIG. 8, the value is forcefully rewritten to “0.0.0”. The version invalidater 308 rewrites the version of the first configuration information, according to the first configuration information input method specific to the scanner 311, keeping a format which supports the scanner 311.

For example, in a case where the scanner 311 selected by the scanner selector 310 has specifications of receiving information through a file, the version invalidater 308 preliminarily rewrites the content of the file. Alternatively, in a case where the scanner 311 selected by the scanner selector 310 has specifications accompanied by any type of communication, the version invalidater 308 forcefully changes the communication content.

Typically, the version of the package does not become lower than “0.0.0”. Accordingly, by performing the processes as described above, vulnerabilities in all the versions of a certain package are detected. That is, presence or absence of the vulnerability to be originally determined by the package name and the version is determined only by the package name.

For example, it is assumed that a package X that is “package 1” with “version 1.3.6” is installed in the device 10_1. In an original case, into the scanner 311, “package 1” is input as the package name, and “1.3.6” is input as the version. As described above, the scanner 311 identifies that the package X is “package 1” and the version is lower than “6.0.0”, and determines that the package X includes a vulnerability “CVE-2021-YYYY” (see FIG. 3).

However, upon input of “0.0.0” as the version by the version invalidater 308, the scanner 311 identifies that the package X is “package 1”, and the version is lower than “1.1.1” and “6.0.0”. Accordingly, it is determined that the a vulnerability “CVE-2018-XXXX” and a vulnerability “CVE-2021-YYYY” are included in “package X” (see FIG. 8).

As described above, when the input version of the package is “0.0.0”, all the known vulnerabilities of “package 1” are detected. The version to be rewritten is not necessarily “0.0.0”, and may be a numeral sufficiently small to an extent that is typically unused as the version number.

The intra DB version invalidater 309 invalidates the version according to a method other than that of the version invalidater 308. According to the save format specific to the first vulnerability DB (i.e., the format supporting the scanner 311), the intra DB version invalidater 309 rewrites the upper limit value of the vulnerability impact range, i.e., the upper limit value of the range of versions affected by the vulnerability, to a value larger than a value that the version is allowed to have. In this embodiment, for example, the value is forcefully rewritten to “to 9999”. Thus, the range of the version is extended.

By performing the processes as described above, typically, the version of the package does not become such a large value. Accordingly, vulnerabilities in all the versions of a certain package are detected. That is, presence or absence of the vulnerability to be originally determined by the package name and the version is determined only by the package name.

For example, it is assumed that a package X that is “package 1” with “version 1.3.6” is installed in the device 10_1. As described above, in an original case, it is determined that a vulnerability “CVE-2021-YYYY” is included in the package X (see FIG. 3).

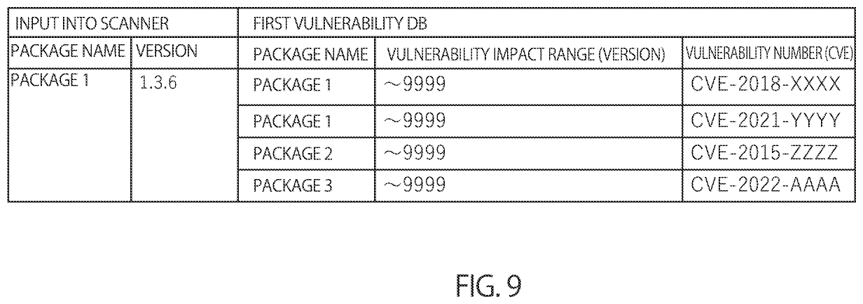

However, when the version range of the first vulnerability information on the first vulnerability DB 302 is rewritten to “to 9999” by the intra DB version invalidater 309, the scanner 311 identifies that the package X is “package 1”, and the version is lower than “9999”. Accordingly, it is determined that a vulnerability “CVE-2018-XXXX” and a vulnerability “CVE-2021-YYYY” are included in the package X (see FIG. 9).

When the version range of the first vulnerability information is “to 9999” as described above, all the known vulnerabilities of “package 1” are thus detected.

Note that the intra DB version invalidater 309 may dynamically hook reading of the first configuration information by the scanner 311, without directly rewriting the value of the first vulnerability DB 302, and rewrite the version part of the first configuration information. The (upper limit of) version range to be rewritten is not necessarily “9999”, and may be a numeral sufficiently large to an extent that is typically unused as the version number. For example, the range may be the maximum value of an integer that the first vulnerability DB 302 can deal with.

It is determined, by the scanner selector 310, which one between the version invalidater 308 and the intra DB version invalidater 309 is used to invalidate the version. For example, in a case where the first vulnerability information is defined accompanied by the upper limit and the lower limit, it may be determined to invalidate the version using the intra DB version invalidater 309.

Note that in a case where the scanner 311 is individually implemented and scanning can be performed without consideration of the version even without rewriting the first configuration information to be input and the content of the first vulnerability DB, the intra DB version invalidater 309 and the version invalidater 308 do not operate.

In any rate, the version is invalidated and then a vulnerability scan is performed for the device 10_1 where the package X is installed, thus detecting all the known vulnerabilities included in all the versions of the package X.

In accordance with the content of the specific information server 6 that changes on a daily basis, the content of the first vulnerability DB 302 changes on a daily basis. Accordingly, even after a vulnerability scan is performed once, the scanner 311 may perform a vulnerability scan again at a later date. In this case, the first configuration information stored in the first configuration information DB 314 may be used.

The CPE searcher 312 searches the column of “CVE” in the CPE candidate DB 304 (see FIG. 4), and determines whether the CVE obtained by the scanner 311 is present. If the CVE is present, the CPE associated with the CVE is identified. For example, the CVEs included in the package X are “CVE-2018-XXXX” and “CVE-2021-YYYY”. Accordingly, “CPE1” and “CPE2” are identified.

The process of the CPE searcher 312 described above depends on the content of the CPE candidate DB 304. In accordance with the content of the versatile information server 7 that is updated on a daily basis, the content of the CPE candidate DB 304 changes on a daily basis. Accordingly, even if the CPE searcher 312 once determines that the CVE obtained by the scanner 311 is absent in the CPE candidate DB 304, this searcher may perform the process described above based on the content of the CPE candidate DB 304 changed at a later date. In this case, the scanner 311 may perform the vulnerability scan again based on the first configuration information stored in the first configuration information DB 314.

The CPE output processor 313 formats the CPE identified by the CPE searcher 312 to a CPE in consideration of the version of the package, and then stores the formatted CPE in the storage 4. “CPE1” and “CPE2” are only CPEs that describe the components affected by the vulnerability included in the conventional versions of the “package 1”. Accordingly, the version parts of the identified CPEs are highly possibly different from the version of the package X actually installed in the device 10_1.

Accordingly, the CPE output processor 313 performs a format process of replacing the version parts of the CPEs with original versions. For example, it is assumed that “CPE1” is described as “cpe:/a:vendor1:package1:10:*”. The CPE output processor 313 replaces the version “10” of “CPE1” “cpe:/a:vendor1:package1:10:*” with “1.3.6” and generates “CPE1′” “cpe:/a:vendor1:package1:1.3.6:*”. Likewise, the CPE output processor 313 replaces the version part of “CPE2” with the original version, and generates “CPE2′”. The CPE output processor 313 outputs the generated “CPE1′” and “CPE2′”. “CPE1′” and “CPE2′” generated by the CPE output processor 313 correspond to the third identifiers that identify a plurality of packages installed in the device 10_1 according to a predetermined format (CPE format) that includes the package name and the version.

Note that the output “CPE1′” and “CPE2′” may be CPEs that are not used on the versatile information server 7 at the time of output. As described above, the CPE is recommended to identify one piece of software or the like by using an existing vendor name and product name according to the rule and then by the element of the version and thereafter. Accordingly, when a new vulnerability is found in the package X, the vulnerability is highly possibly described by a CPE coinciding with the “CPE1′” or “CPE2′”.

In a case of multiple CPEs identified by the CPE searcher, there can be an CPE that includes no package name and no version among the CPEs. As for such CPEs, the CPEs may be output without replacing the version parts.

As described above, CPEs (“CPE1′”, “CPE2′”, etc.) that are highly possibly appropriate CPEs are output by the CPE output processor 313. The output CPEs are associated with the device 10_1 in the storage 4 and saved.

According to the processes described above, the CPE can be identified by one piece of first configuration information (one pair of a package name and a version). The identification is repeated for the first configuration information on all the packages included in the device 10_i, and the CPE identification and save process for all the packages installed in the device 10_i are performed. Accordingly, the second configuration information as shown in FIG. 5 is generated.

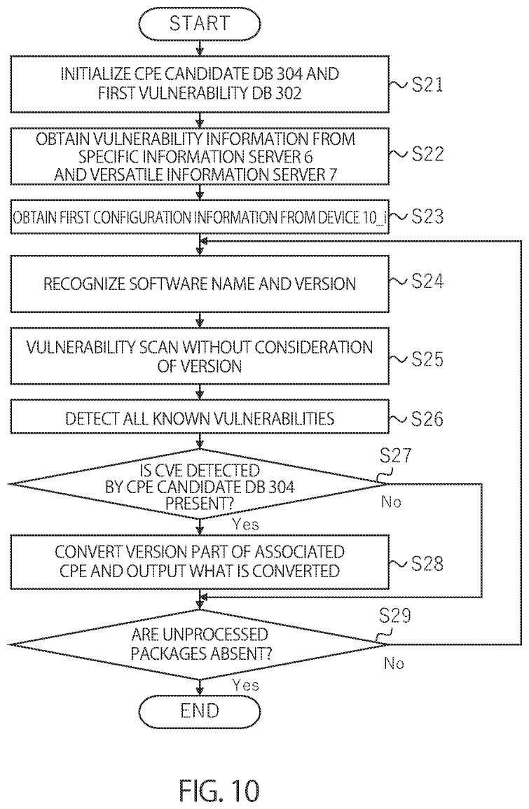

FIG. 10 is a flowchart for describing processes executed by the configuration information converter 3. Hereinafter, referring to the drawings, the processes executed by the configuration information converter 3 are described.

First, the configuration information converter 3 initializes the first vulnerability DB 302 and the CPE candidate DB 304 (step S21).

Next, the first vulnerability information obtainer 301 and the second vulnerability information obtainer 303 obtain the first vulnerability information and the second vulnerability information respectively from the specific information server 6 and the versatile information server 7 (step S22). The obtained first vulnerability information and second vulnerability information are respectively stored in the first vulnerability DB 302 and the CPE candidate DB 304.

Next, the first configuration information obtainer 305 obtains the first configuration information on all the packages included in the device 10_i from the device 10_i (step S23).

Next, the name identifier 306 and the version identifier 307 respectively identify the name and the version of the package, based on the first configuration information obtained by the first configuration information obtainer 305 (step S24).

Next, in the state where the version is invalidated by the version invalidater 308, the intra DB version invalidater 309 or the individually implemented scanner 311, the scanner 311 scans the first configuration information (step S25).

Next, as a result of the scan, the scanner 311 detects all the vulnerabilities (CVEs) included in the package described above in the past irrespective of the version (step S26).

Next, the CPE searcher 312 determines whether any detected CVE is present in the CPE candidate DB 304 (step S27).

If it is determined that the detected CVE is present (step S27: Yes), the version part of the CPE associated with the CVE is replaced with the version of the actual package, which is then output (step S28).

If it is determined that any detected CVE is not present, the processing transitions to step S29 (step S27: No).

Next, it is determined whether an unprocessed package is absent among the packages installed in the device 10_i (step S29).

If the unprocessed packages is not absent, the processing returns to step S24, and processes in steps S24 to S28 are performed for the unprocessed package (step S29: No).

If the unprocessed package is absent, the processing is finished (step S29: Yes).

Note that if it is determined that any detected CVE is not present in step S27, steps S21 to S27 may be executed again using a new CPE candidate DB 304 and first vulnerability DB 302 at a later date.

As described above, according to the first configuration example in one embodiment, the first configuration information described by the first identifier can be converted into the second configuration information described by the appropriate third identifier (CPE′).

### Second Configuration Example

The same platform is provided with one specific information server 6. Note that the granularity of assuming that the platform is the same is various. For example, even if an OS is largely changed, the platform is assumed to be the same over a long time period in a certain case, while being assumed to be another platform with respect to minor difference in release in another case. In the latter case, if only the first vulnerability information in one specific information server 6 is used, only vulnerabilities found in a short time period are possibly found.

For example, it is assumed that for a certain OS that a certain vendor is providing, the vendor newly releases “OS ver2” in addition to an existing version “OS ver1”. In this case, the vendor newly provides a specific information server 6 supporting “OS ver2” in addition to a specific information server 6 supporting “OS ver1”. In a case where “package 1” with “version 3” was installed before “OS ver2” is released, there is a high possibility that the specific information server 6 for “OS ver2” does not include the vulnerability information on “package 1” with “version 3” and therebefore.

Consequently, to detect all the vulnerabilities of the conventional versions of the package, not only the specific information server 6 (and the first vulnerability DB based on this) provided for the latest platform, but also specific information servers 6 provided for conventional platforms are required to be referred to.

The first configuration example assumes that the number of specific information servers 6 is not increased by release of the platform or the like. In the second configuration example, processes in a case where the number of specific information servers 6 is increased by release of the platform or the like are described.

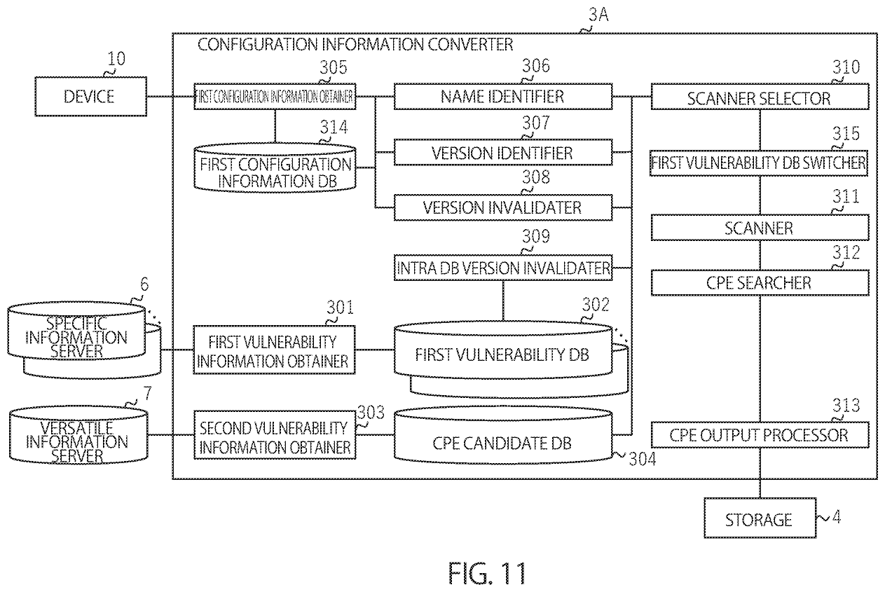

FIG. 11 is a block diagram of the configuration information converter 3A that is an information processing apparatus according to a second configuration example of one embodiment. Elements having the same names or functions as those of the configuration example described above are assigned the same symbols. Hereinafter, the description is omitted except on changed or added items.

The configuration information converter 3A includes a first vulnerability DB switcher 315. The first vulnerability DB switcher 315 improves the accuracy of the vulnerability scan by the scanner 311 without consideration of the version.

The first vulnerability DB switcher 315 switches the first vulnerability DB 302 used by the scanner 311, to the first vulnerability DB 302 for different platforms (i.e., conventional platforms), thus detecting more vulnerabilities.

For example, the first vulnerability DB switcher 315 may replace a file in the first vulnerability DB 302 to be read by the scanner 311, with a symbolic link, or rewrite the argument and allow a different file to be read. The first vulnerability DB 302 that is of the same format and that the scanner 311 can read without contradiction can be switched by the first vulnerability DB switcher 315. In other words, in this embodiment, in the case where there are a plurality of first vulnerability DBs 302 that the scanner 311 can read without contradiction, the plurality of first vulnerability DBs 302 are assumed as the first vulnerability DBs 302 on the same platform.

As described above, according to the second configuration example of one embodiment, even in the case where the number of specific information servers 6 is increased by release of the platform or the like, the vulnerabilities of all the conventional versions of the package can be detected.

### Third Configuration Example

Preferably, it is assumed that when a vulnerability is found in one package, association is only with one type of CPE (i.e., the CVE is associated with the CPE on a one-to-one basis).

On the other hand, there are OSs and hardware where a package is embedded as one component, in the world. In this case, when a vulnerability is found in the package, it is sometimes assumed that a vulnerability is also in the OSs and hardware that use the package.

For example, if a vulnerability “CVE-2022-XXXX” affects “version 1” of “package1” developed by “vendor” corporation, the following content is listed on the versatile information server 7.

Vulnerability Number

CVE-2022-XXXX

Overview

The vulnerability is a vulnerability pertaining to “package 1” . . . .

Affected components (CPE list)
cpe:/a:vendor:package1:1:*
cpe:/o:vendor:os_system:2:*
cpe:/h:vendor:hardware1:1:*

As described above, the affected components (CPE list) include, not only a package “cpe:/a:vendor1:package1:1:*” that is a fundamental cause of the vulnerability, but also an OS “cpe:/o:vendor2:os_system:2:*” and hardware “cpe:/h:vendor3:hardware1:1:*” that use “package1”.

However, in view of vulnerability management, cases of intending to identify an OS or hardware that uses the package are rare. In most cases, a fundamental cause of a vulnerability “cpe:/a:vendor1:package1:1:*” is intended to be identified.

In cases other than the examples described above, it is conceivable that besides an appropriate CPE, a plurality of inappropriate CPEs are listed for one CVE.

Based on web information on the versatile information server 7 as described above, the second vulnerability information obtainer 303 additionally updates the second vulnerability information stored in the CPE candidate DB 304, thus associating one CVE with a plurality of CPEs. Accordingly, the second configuration information stored in the storage 4 is redundant, and unimportant vulnerabilities are detected by the vulnerable device determiner 5.

The first configuration example and the second configuration example assume that the CVE is associated with the CPE on a one-to-one basis on the versatile information server 7. In the third configuration example, processes of selecting a CPE having higher priority when the CVE is associated with CPEs on a one-to-multiple basis are described.

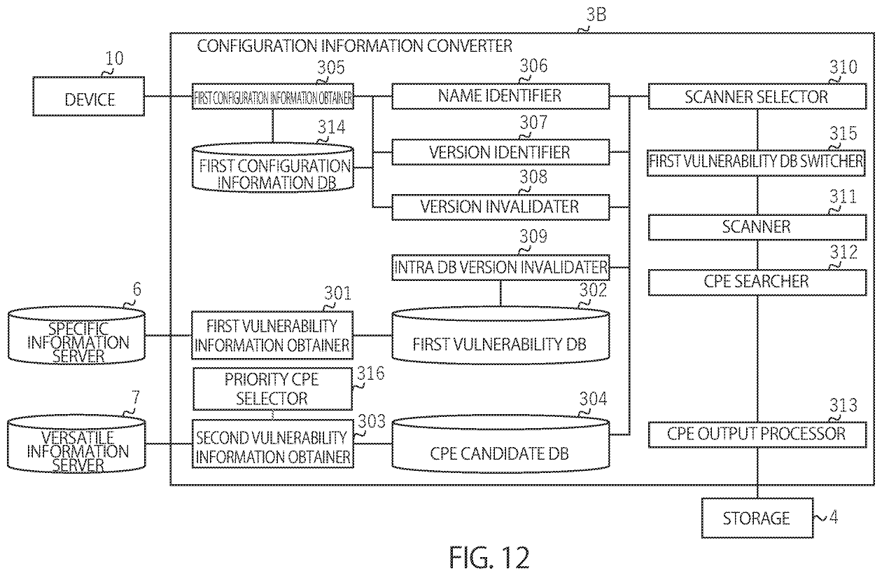

FIG. 12 is a block diagram of the configuration information converter 3B that is an information processing apparatus according to a third configuration example of one embodiment. Elements having the same names or functions as those of the configuration example described above are assigned the same symbols. Hereinafter, the description is omitted except on changed or added items.

The configuration information converter 3B includes a priority CPE selector 316.

The priority CPE selector 316 supports updating of the CPE candidate DB 304 that can identify a CPE having higher priority. After the CPE candidate DB 304 is updated, the priority CPE selector 316 rewrites the CPE candidate DB 304 to a CPE candidate DB 304 that only includes priority CPEs.

Specifically, first, the priority CPE selector 316 scans the CPE candidate DB 304, and searches for a CVE associated with a plurality of CPEs. If the CVE concerned is present as a result of the search, the web information on the versatile information server 7 is referred to with the CVE as a key, and the CPE listed at the top of the CPE list is adopted as the priority CPE. That is, the beginning CPE in a case where the CPEs in the CPE list are arranged in the order of the list is adopted as the priority CPE. The priority CPE selector 316 then removes the CPEs other than the priority CPE associated with the CVE concerned.

Because the website has characteristics of being viewed by people, enumeration is made from the vulnerability having an important meaning in many cases. Typically, as described above, enumeration is made in an order of, first, a package having a fundamental cause of the vulnerability, subsequently, an OS including the package, and hardware. Accordingly, there is a high possibility that the CPE described at the top of the CPE list is a desired and appropriate CPE.

When the second vulnerability information stored in the CPE candidate DB 304 is additionally updated based on the structured vulnerability information (second vulnerability information), such as JSON or XML, distributed by the versatile information server 7, the CPE enumeration order is inconstant in the CPE candidate DB 304 in some cases. Accordingly, the priority CPE is selected based on the vulnerability information in the versatile information server 7 described in the web.

After the process described above, the CPE searcher 312 performs the CPE search using the CPE candidate DB 304 rewritten by the priority CPE selector 316, thus identifying only the CPE serving as the fundamental cause of the vulnerability for one CVE.

Note that there can be a method of not directly rewriting the CPE candidate DB 304. For example, the CPE searcher 312 may perform a process or the like that refers to the priority CPE selector 316 every time this searcher identifies the CPE using the CPE candidate DB 304, and ignores the CPE if the identified CPE is not the priority CPE.

As described above, according to the third configuration example of one embodiment, only a desired CPE or a CPE having a high priority can be associated with the CVE identified by the scanner 311. Accordingly, the second configuration information can be prevented from being redundant.

### Fourth Configuration Example

When a plurality of vulnerabilities are found for one package, the CPE is identified from these vulnerabilities. On the other hand, if a specific CPE is assigned as the operation of the vulnerability monitor system 1 progresses, knowledge that the other CPEs are erroneous or unnecessary is sometimes obtained.

The association of the plurality of CPEs with one package even after obtainment of the knowledge described above leaves the second configuration information stored in the storage 4 redundant. In the fourth configuration example, processes of preliminarily eliminating such redundant CPEs are described.

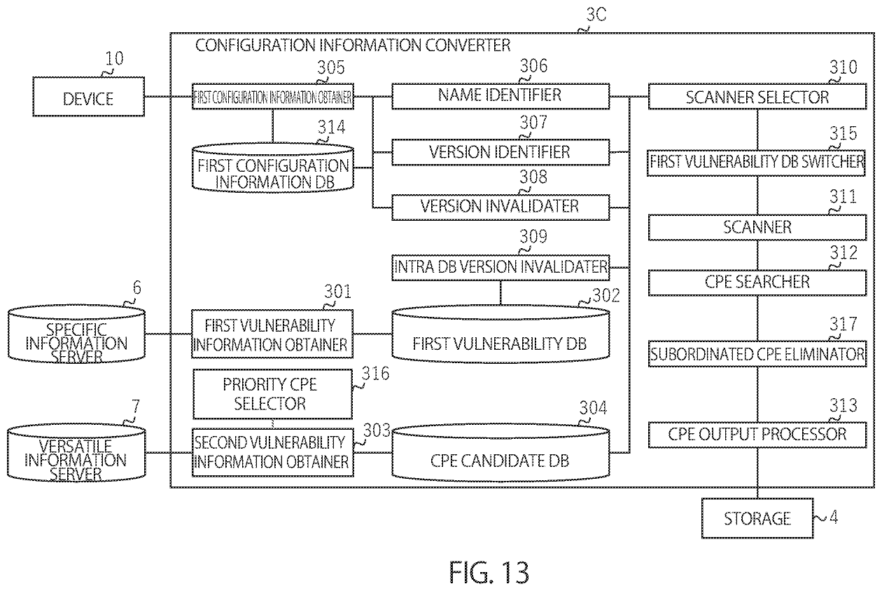

FIG. 13 is a block diagram of the configuration information converter 3C that is an information processing apparatus according to a fourth configuration example of one embodiment. Elements having the same names or functions as those of the configuration example described above are assigned the same symbols. Hereinafter, the description is omitted except on changed or added items.

The configuration information converter 3C includes a subordinated CPE eliminator 317. When a preliminarily designated CPE is selected, the subordinated CPE eliminator 317 eliminates the other CPEs.

After completion of the process of the CPE searcher 312, the subordinated CPE eliminator 317 determines whether or not the CPEs selected by the CPE searcher 312 include the CPE preliminarily designated by the user. When the designated CPE is included, the other CPEs are eliminated.

As described above, according to the fourth configuration example of one embodiment, when the specific CPE is assigned, preliminary elimination of the CPEs other than the specific CPE can prevent the second configuration information from being redundant. Furthermore, the processing load on the CPE output processor 313 can be reduced.

### (Hardware Configuration)

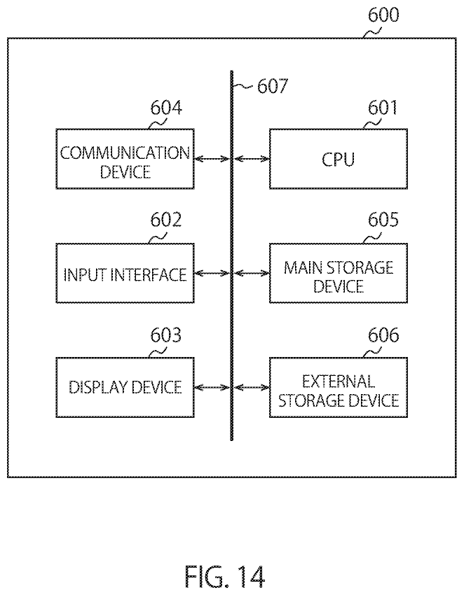

FIG. 14 illustrates a hardware configuration of the information processing device according to each embodiment. The information processing device is configured as a computer device 600. The computer device 600 includes a CPU 601, an input interface 602, a display device 603, a communication device 604, a main storage device 605, and an external storage device 606, and these components are mutually connected through a bus 607.

The CPU (central processing unit) 601 executes an information processing program as a computer program on the main storage device 605. The information processing program is a computer program configured to achieve each above-described functional composition of the present device. The information processing program may be achieved by a combination of a plurality of computer programs and scripts instead of one computer program. Each functional composition is achieved as the CPU 601 executes the information processing program.

The input interface 602 is a circuit for inputting, to the present device, an operation signal from an input device such as a keyboard, a mouse, or a touch panel. The input interface 602 corresponds to the input device in each embodiment.

The display device 603 displays data output from the present device. The display device 603 is, for example, a liquid crystal display (LCD), an organic electroluminescence display, a cathode-ray tube (CRT), or a plasma display (PDP) but is not limited thereto. Data output from the computer device 600 can be displayed on the display device 603. The display device 603 corresponds to the output device in each embodiment.

The communication device 604 is a circuit for the present device to communicate with an external device in a wireless or wired manner. Data can be input from the external device through the communication device 604. The data input from the external device can be stored in the main storage device 605 or the external storage device 606.

The main storage device 605 stores, for example, the information processing program, data necessary for execution of the information processing program, and data generated through execution of the information processing program. The information processing program is loaded and executed on the main storage device 605. The main storage device 605 is, for example, a RAM, a DRAM, or an SRAM but is not limited thereto. Each storage or database in the information processing device in each embodiment may be implemented on the main storage device 605.

The external storage device 606 stores, for example, the information processing program, data necessary for execution of the information processing program, and data generated through execution of the information processing program. The information processing program and the data are read onto the main storage device 605 at execution of the information processing program. The external storage device 606 is, for example, a hard disk, an optical disk, a flash memory, or a magnetic tape but is not limited thereto. Each storage or database in the information processing device in each embodiment may be implemented on the external storage device 606.

The information processing program may be installed on the computer device 600 in advance or may be stored in a storage medium such as a CD-ROM. Moreover, the information processing program in each embodiment may be uploaded on the Internet.

The present device may be configured as a single computer device 600 or may be configured as a system including a plurality of mutually connected computer devices 600.

While certain embodiment have been described, these embodiment have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments as described before may be configured as below.

### CLAUSES

Clause 1. An information processing apparatus, comprising:
a first vulnerability information obtainer configured to obtain, from a first server, first vulnerability information that associates a first identifier identifying software specific to the platform with a vulnerability identifier identifying a vulnerability of the software, the first identifier identifying the software by a name and a version of the software;
a second vulnerability information obtainer configured to obtain, from a second server, second vulnerability information that associates a second identifier identifying software included in a device, with the vulnerability identifier, the second identifier identifying the software by a name and a version of the software according to a predetermined format;
a first configuration information obtainer configured to obtain, from a vulnerability test target device, first configuration information that includes a name and a version of target software included in the target device;
a scanner configured to detect a first identifier including the name of the target software, from the first vulnerability information, based on the first configuration information, and identify the vulnerability identifier associated with the detected first identifier;
a searcher configured to identify a second identifier that is associated with the vulnerability identifier identified by the scanner, and includes a name of software identical to the name of the target software, based on the second vulnerability information; and
an output processor configured to generate a third identifier by replacing the version included in the second identifier identified by the searcher with the version of the target software, the third identifier identifying the target software included in the target device, according to the predetermined format.

Clause 2. The information processing apparatus according to clause 1, further comprising
a version invalidater configured to rewrite a value of the version of the target software in the obtained first configuration information, to a value smaller than a value that the version is allowed to have,
wherein the first identifier included in the first vulnerability information identifies the software by the name of the software and a range of the version, and
the scanner detects the first identifier where the version included in the first configuration information is included in the range of the version.

Clause 3. The information processing apparatus according to clause 1 or 2,
wherein the first identifier included in the first vulnerability information identifies the software by the name of the software and a range of the version,
the apparatus further comprises a DB version invalidater configured to extend the range by rewriting an upper limit value of the range of the version of the obtained first vulnerability information to a value larger than a value that the version is allowed to have, and
the scanner detects the first identifier where the version included in the first configuration information is included in the extended range.

Clause 4. The information processing apparatus according to any one of clauses 1 to 3,
wherein the first vulnerability information obtainer obtains a plurality of pieces of the first vulnerability information, from a plurality of the first servers specific to a plurality of the platforms,
the pieces of the first vulnerability information each associate a first identifier where the name of the software is identical and the version is different, with the vulnerability identifier, and
the scanner detects the first identifier including the name of the software, from each piece of the first vulnerability information, and identifies the vulnerability identifier associated with the detected first identifier.

Clause 5. The information processing apparatus according to any one of clauses 1 to 4,
wherein the second vulnerability information obtained from the second server associates a plurality of the second identifiers with the single vulnerability identifier, and a plurality of the second identifiers in the second vulnerability information are arranged in any order,
the apparatus further comprises a selector configured to select a second identifier at a position satisfying a selection condition from among the second identifiers in the second vulnerability information, and
the searcher only uses the selected second identifier and the vulnerability identifier, as the second vulnerability information.

Clause 6. The information processing apparatus according to clause 5,
wherein the position satisfying the selection condition is a beginning position.

Clause 7. The information processing apparatus according to any one of clauses 1 to 6,
wherein the scanner detects a plurality of the first identifiers from the first vulnerability information, and identifies a plurality of the vulnerability identifiers associated with the plurality of detected first identifiers,
the apparatus further comprises an eliminator configured to eliminate the second identifier so that when a plurality of the second identifiers identified by the searcher with respect to the plurality of vulnerability identifiers include a designated second identifier, the eliminator eliminates the second identifiers other than the designated second identifier from among the second identifiers identified by the searcher, and
the output processor generates the third identifier of the target software using only the designated second identifier.

Clause 8. An information processing method, comprising:
obtaining from a first server, first vulnerability information that associates a first identifier identifying software specific to the platform with a vulnerability identifier identifying a vulnerability of the software,
the first identifier identifying the software by a name and a version of the software;
obtaining from a second server, second vulnerability information that associates a second identifier identifying software included in a device, with the vulnerability identifier, the second identifier identifying the software by a name and a version of the software according to a predetermined format;
obtaining from a vulnerability test target device, first configuration information that includes a name and a version of target software included in the target device;
detecting a first identifier including the name of the target software, from the first vulnerability information, based on the first configuration information, and identify the vulnerability identifier associated with the detected first identifier;
identifying a second identifier that is associated with the vulnerability identifier identified by the scanner, and includes a name of software identical to the name of the target software, based on the second vulnerability information; and
generating a third identifier by replacing the version included in the second identifier identified by the searcher with the version of the target software, the third identifier identifying the target software included in the target device, according to the predetermined format.

Clause 9. An information processing system, comprising:
a vulnerability test target device;
a platform-specific first server configured to manage a vulnerability of software specific to a platform;
a second server configured to manage a vulnerability of a component included in the target device; and an information processing apparatus configured to be capable of communicating with the target device, the first server and the second server,
wherein the information processing apparatus comprises:
   a first vulnerability information obtainer configured to obtain, from the first server, first vulnerability information that associates a first identifier identifying software specific to the platform with a vulnerability identifier identifying a vulnerability of the software, the first identifier identifying the software by a name and a version of the software;
   a second vulnerability information obtainer configured to obtain, from the second server, second vulnerability information that associates a second identifier identifying software included in a device, with the vulnerability identifier, the second identifier identifying the software by a name and a version of the software according to a predetermined format;
   a first configuration information obtainer configured to obtain, from the vulnerability test target device, first configuration information that includes a name and a version of target software included in the target device;
   a scanner configured to detect a first identifier including the name of the target software, from the first vulnerability information, based on the first configuration information, and identify the vulnerability identifier associated with the detected first identifier;
   a searcher configured to identify a second identifier that is associated with the vulnerability identifier identified by the scanner, and includes a name of software identical to the name of the target software, based on the second vulnerability information;
   an output processor configured to generate a third identifier by replacing the version included in the second identifier identified by the searcher with the version of the target software, the third identifier identifying the target software included in the target device, according to the predetermined format; and
   a vulnerable device determiner configured to determine a vulnerability of the target device by testing whether the second vulnerability information obtained from the second server includes the second identifier coinciding with the third identifier.

1. An information processing apparatus, comprising:
a first vulnerability information obtainer configured to obtain, from a first server, first vulnerability information that associates a first identifier identifying software specific to the platform with a vulnerability identifier identifying a vulnerability of the software, the first identifier identifying the software by a name and a version of the software;
a second vulnerability information obtainer configured to obtain, from a second server, second vulnerability information that associates a second identifier identifying software included in a device, with the vulnerability identifier, the second identifier identifying the software by a name and a version of the software according to a predetermined format;
a first configuration information obtainer configured to obtain, from a vulnerability test target device, first configuration information that includes a name and a version of target software included in the target device;
a scanner configured to detect a first identifier including the name of the target software, from the first vulnerability information, based on the first configuration information, and identify the vulnerability identifier associated with the detected first identifier;
a searcher configured to identify a second identifier that is associated with the vulnerability identifier identified by the scanner, and includes a name of software identical to the name of the target software, based on the second vulnerability information; and
an output processor configured to generate a third identifier by replacing the version included in the second identifier identified by the searcher with the version of the target software, the third identifier identifying the target software included in the target device, according to the predetermined format.

2. The information processing apparatus according to claim 1, further comprising
a version invalidater configured to rewrite a value of the version of the target software in the obtained first configuration information, to a value smaller than a value that the version is allowed to have,
wherein the first identifier included in the first vulnerability information identifies the software by the name of the software and a range of the version, and
the scanner detects the first identifier where the version included in the first configuration information is included in the range of the version.

3. The information processing apparatus according to claim 1,
wherein the first identifier included in the first vulnerability information identifies the software by the name of the software and a range of the version,
the apparatus further comprises a DB version invalidater configured to extend the range by rewriting an upper limit value of the range of the version of the obtained first vulnerability information to a value larger than a value that the version is allowed to have, and
the scanner detects the first identifier where the version included in the first configuration information is included in the extended range.

4. The information processing apparatus according to claim 1,
wherein the first vulnerability information obtainer obtains a plurality of pieces of the first vulnerability information, from a plurality of the first servers specific to a plurality of the platforms,
the pieces of the first vulnerability information each associate a first identifier where the name of the software is identical and the version is different, with the vulnerability identifier, and
the scanner detects the first identifier including the name of the software, from each piece of the first vulnerability information, and identifies the vulnerability identifier associated with the detected first identifier.

5. The information processing apparatus according to claim 1,
wherein the second vulnerability information obtained from the second server associates a plurality of the second identifiers with the single vulnerability identifier, and a plurality of the second identifiers in the second vulnerability information are arranged in any order,
the apparatus further comprises a selector configured to select a second identifier at a position satisfying a selection condition from among the second identifiers in the second vulnerability information, and
the searcher only uses the selected second identifier and the vulnerability identifier, as the second vulnerability information.

6. The information processing apparatus according to claim 5,
wherein the position satisfying the selection condition is a beginning position.

7. The information processing apparatus according to claim 1,
wherein the scanner detects a plurality of the first identifiers from the first vulnerability information, and identifies a plurality of the vulnerability identifiers associated with the plurality of detected first identifiers,
the apparatus further comprises an eliminator configured to eliminate the second identifier so that when a plurality of the second identifiers identified by the searcher with respect to the plurality of vulnerability identifiers include a designated second identifier, the eliminator eliminates the second identifiers other than the designated second identifier from among the second identifiers identified by the searcher, and
the output processor generates the third identifier of the target software using only the designated second identifier.

8. An information processing method, comprising:
obtaining from a first server, first vulnerability information that associates a first identifier identifying software specific to the platform, with a vulnerability identifier identifying a vulnerability of the software, the first identifier identifying the software by a name and a version of the software;
obtaining from a second server, second vulnerability information that associates a second identifier identifying software included in a device with the vulnerability identifier, the second identifier identifying by a name and a version of the software according to a predetermined format;
obtaining from a vulnerability test target device, first configuration information that includes a name and a version of target software included in the target device;
detecting a first identifier including the name of the target software, from the first vulnerability information, based on the first configuration information, and identify the vulnerability identifier associated with the detected first identifier;
identifying a second identifier that is associated with the vulnerability identifier identified by the scanner, and includes a name of software identical to the name of the target software, based on the second vulnerability information; and
generating a third identifier by replacing the version included in the second identifier identified by the searcher with the version of the target software, the third identifier identifying the target software included in the target device, according to the predetermined format.

9. An information processing system, comprising:
a vulnerability test target device;
a platform-specific first server configured to manage a vulnerability of software specific to a platform;
a second server configured to manage a vulnerability of a component included in the target device; and
an information processing apparatus configured to be capable of communicating with the target device, the first server and the second server,
wherein the information processing apparatus comprises:
a first vulnerability information obtainer configured to obtain, from the first server, first vulnerability information that associates a first identifier identifying software specific to the platform, with a vulnerability identifier identifying a vulnerability of the software, the first identifier identifying the software by a name and a version of the software;
a second vulnerability information obtainer configured to obtain, from the second server, second vulnerability information that associates a second identifier identifying software included in a device, with the vulnerability identifier, the second identifier identifying the software by a name and a version of the software according to a predetermined format;
a first configuration information obtainer configured to obtain, from the vulnerability test target device, first configuration information that includes a name and a version of target software included in the target device;
a scanner configured to detect a first identifier including the name of the target software, from the first vulnerability information, based on the first configuration information, and identify the vulnerability identifier associated with the detected first identifier;
a searcher configured to identify a second identifier that is associated with the vulnerability identifier identified by the scanner, and includes a name of software identical to the name of the target software, based on the second vulnerability information;
an output processor configured to generate a third identifier by replacing the version included in the second identifier identified by the searcher with the version of the target software, the third identifier identifying the target software included in the target device, according to the predetermined format; and
a vulnerable device determiner configured to determine a vulnerability of the target device by testing whether the second vulnerability information obtained from the second server includes the second identifier coinciding with the third identifier.
